(19) United States
(12) Patent Application Publication
(10) Pub. No.: US 2018/0285064 A1
(43) Pub. Date: Oct. 4, 2018

(54) INFORMATION PROCESSING METHOD AND ELECTRONIC APPARATUS

(71) Applicant: Lenovo (Beijing) Co., Ltd., Beijing (CN)

(72) Inventors: Ya ZHANG, Beijing (CN); Yan MA, Beijing (CN); Rui WANG, Beijing (CN)

(21) Appl. No.: 15/813,724

(22) Filed: Nov. 15, 2017

(30) Foreign Application Priority Data
Mar. 28, 2017 (CN) 201710194226.3

(51) Int. Cl. G06F 3/16; G10L 15/26; G10L 15/22

(52) U.S. Cl. CPC G06F 3/167; G10L 15/22; G10L 15/265

(57) ABSTRACT

An information processing method includes acquiring audio data collected by at least one remotely-arranged audio collection device, analyzing the audio data to obtain a analysis result, performing processing based on the analysis result to obtain response information corresponding to the audio data, and transmitting the response information to an audio output device in a same space as the at least one audio collection device for broadcasting.

### CROSS-REFERENCES TO RELATED APPLICATIONS

This application claims priority to Chinese Patent Application No. 201710194226.3, filed on Mar. 28, 2017, the entire contents of which are hereby incorporated by reference.

### TECHNICAL FIELD

The present disclosure generally relates to the technical field of information processing and, more particularly, to a method and an electronic apparatus for information processing.

### BACKGROUND

Because smart devices such as smart cellphones and tablets are popular and heavily used, chances that customers use traditional computers (e.g., desktop, notebook) become lower and lower. In particular, the frequency that home computers are used ever decreases. Users who own a computer often and basically treat the computer as a tool, and when the users use the computer for operation, the computer often needs to be boosted up and later shut down after operation is completed. However, the scenarios where the users have to stay close to the electronic apparatus to use the electronic apparatus for information processing result in a very low utilization rate of the traditional computer. Further, the interaction modes between the users and the electronic apparatus (e.g., computer) are restricted.

### BRIEF SUMMARY OF THE DISCLOSURE

One aspect of the present disclosure provides an information processing method including acquiring audio data collected by at least one remotely-arranged audio collection device, analyzing the audio data to obtain a analysis result, performing processing based on the analysis result to obtain response information corresponding to the audio data, and transmitting the response information to an audio output device in a same space as the at least one audio collection device for broadcasting.

Another aspect of the present disclosure provides an electronic apparatus including a data acquisition circuit, a processing circuit coupled to the data acquisition circuit, and an output control circuit coupled to the processing circuit. The data acquisition circuit acquires remotely-generated audio data collected by at least one audio collection device. The processing circuit: analyzes the audio data to obtain a analysis result and performs processing based on the analysis result to obtain response information corresponding to the audio data. The output control circuit transmits the response information to an audio output device in a same space as the at least one audio collection device for broadcasting

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions in embodiments of the present disclosure, drawings for illustrating the embodiments are briefly introduced below. Obviously, the drawings described hereinafter are only directed to some embodiments of the present disclosure, and it is possible for those ordinarily skilled in the art to derive other drawings from such drawings without creative effort.

FIG. 1 illustrates a flow chart of an information processing method consistent with the present disclosure;

FIG. 2 illustrates a schematic view of a scenario consistent with the present disclosure;

FIG. 3A illustrates a schematic view of another scenario consistent with the present disclosure;

FIG. 3B illustrates a schematic view of another scenario consistent with the present disclosure;

FIG. 4 illustrates a schematic view of another scenario consistent with disclosed embodiments;

FIG. 5 illustrates a schematic view of another scenario consistent with the present disclosure;

FIG. 6 illustrates a schematic view of another scenario consistent with the present disclosure;

FIG. 7 illustrates a schematic view of another scenario consistent with the present disclosure;

FIG. 8 illustrates a schematic view of another scenario consistent with the present disclosure; and

FIG. 9 illustrates a schematic structural diagram of an electronic apparatus consistent with the present disclosure.

### DETAILED DESCRIPTION

Various aspects and features of the present disclosure will be described hereinafter with reference to the accompanying drawings. It should be understood that, various modifications may be made to the disclosed embodiments. Thus, the specification shall not be construed as limiting, but is merely intended to illustrate examples of the embodiments. Other modifications obtainable by those skilled in the relevant art shall all fall within the scope and spirit of the present disclosure.

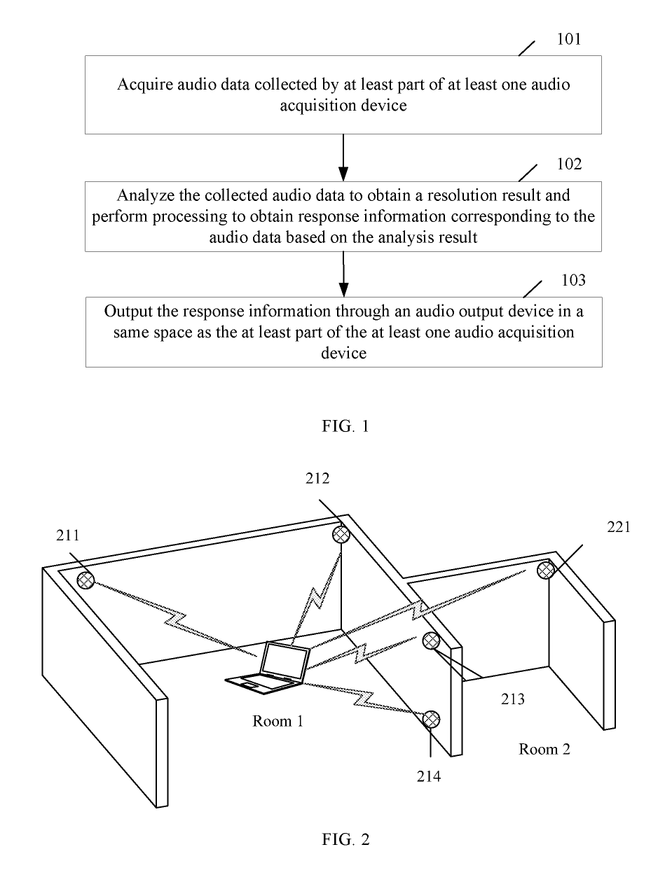

The present disclosure provides an information processing method applicable to an electronic apparatus. The electronic apparatus may be configured for establishing a communication connection with at least one audio collection device, and at least part of audio collection devices among the at least one audio collection device have physical locations different from the physical location of the electronic apparatus. That is, with respect to the electronic apparatus, the at least one audio collection device is remotely arranged. FIG. 1 illustrates a flow chart of an information processing method consistent with the present disclosure, as described in detail below.

101: acquiring audio data collected by at least part of at least one audio collection device, i.e., acquiring audio data collected by one or more of the at least one audio collection device. Optionally, the at least one audio collection device may interact with each other via a wireless connection, and the wireless connection may be implemented through WiFi or Bluetooth.

In one embodiment, the at least one audio collection device may interact with each other to transmit the audio data collected by the at least part of the audio collection devices to an audio pre-processing circuit via the wireless connection. The audio pre-processing circuit may be coupled to the electronic apparatus, and may be configured for pre-processing the audio data and further sending the pre-processed audio data to the electronic apparatus.

In another embodiment, the audio pre-processing circuit may not be needed. That is, the at least one audio collection device may interact with each other to transmit the collected audio data to the electronic apparatus without the audio pre-processing circuit.

Optionally, a router may be used to interact with the electronic apparatus and the at least one audio collection device to achieve a longer delivery distance for the collected audio data. As such, even when a user is relatively far from the electronic apparatus, the audio generated by the user that is collected by a nearby audio collection device may still and eventually be transmitted to the electronic apparatus for further processing. Here, the user acts as a source of the audio data, also referred to as an “audio source.”

102: analyzing the collected audio data to obtain a analysis result, and based on the analysis result, performing processing to obtain response information for the audio data, i.e., response information corresponding to the audio data. For example, the analysis result is processed to obtain the response information. Optionally, performing processing to obtain response information for the audio data may include using the electronic apparatus to perform semantic recognition and semantic analysis of the collected audio data, thereby generating the response information. The response information may be a response audio or music generated locally or by a server, in response to the collected audio data. However, the present disclosure is not limited thereto.

103: through an audio output device disposed in a same space as the at least part of the audio collection devices, outputting the response information. In some embodiments, after the response information is obtained, the electronic apparatus may send the response information to an audio output device, for example, via a wireless connection, to broadcast the response information.

In one example, the disclosed audio collection device may be a microphone in any form. The at least one audio collection device may form an audio collection array. Further, when the at least one audio collection device is disposed at different physical locations of a target space, sounds from different physical locations and surroundings thereof may be collected.

As described above, the audio data may be collected by at least part of the at least one audio collection device. Optionally, the number of the at least part of the audio collection device may be one or more, and through the process at 101, what is obtained is the collected audio data.

When the number of the at least part of the audio collection device is one, it may be understood that one audio collection device collects the audio data. When the number of the at least part of the audio collection devices is two or more, it may be understood that the user is in a target space where a plurality of audio collection devices are able to collect the audio data of the user, and the plurality of audio collection devices may each collect audio data.

Further, two or more sub-spaces may exist in the target space, and the two or more sub-spaces may be connected via one or more connection devices. The connection devices may be for example, the aforementioned audio collection devices being able to communicate with each other via a wireless connection. For example, FIG. 2 illustrates a schematic view of a scenario consistent with the present disclosure.

As shown in FIG. 2, the target space may be a house including two sub-spaces, and the two sub-spaces may be two rooms denoted by room 1 and room 2. One or more audio collection devices may be respectively provided in each room. For example, as shown in FIG. 2, four audio collection devices are disposed in room 1, including audio collection device 211, audio collection device 212, audio collection device 213, and audio collection device 214. One audio collection device is disposed in room 2, i.e., audio collection device 221.

Further, an electronic apparatus may be placed in room 1, and the aforementioned audio collection devices (211, 212, 213, 214, and 221) may each establish a connection with the electronic apparatus that performs audio data processing via a wired or wireless connection. Optionally, the electronic apparatus may be a laptop, as illustrated in FIG. 2.

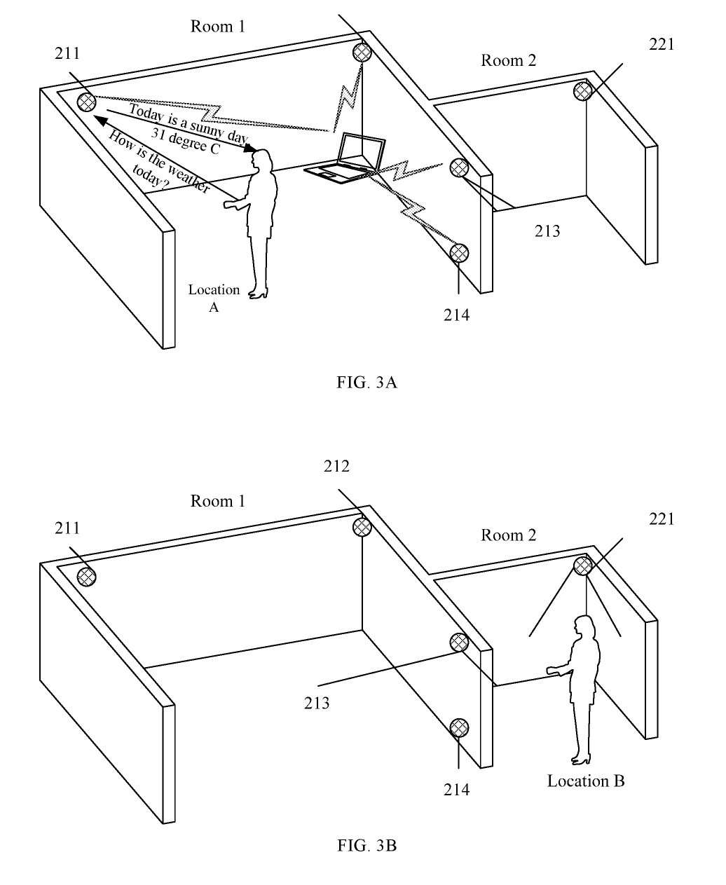

Based on FIG. 2, FIG. 3A illustrates a schematic view of another scenario consistent with the present disclosure. Referring to FIG. 3A, when a user is back home and stands at a location A of the room 1, the user may make a sound, and the audio collection devices 211, 212, 213, and 214 may all collect audio data from the user. That is, the audio collection devices 211, 212, 213, and 214 may be considered as the aforementioned at least part of the audio collection devices. Optionally, when the user is relatively close to the audio collection device 211, the audio collection device 211 may be the only audio collection device that collects the audio data from the user. Under such situation, the audio collection device 211 may be treated as the at least part of the audio collection devices.

Further, referring to FIG. 3A, content information of “how is the weather today” may be extracted from the audio data sent by the user. Optionally, the audio collection device 211 may collect and send the audio data from the user to a notebook. After processing the collected audio information, the notebook may acquire the current weather condition and send a feedback “today is a sunny day, 31 degree C.” to the user via a loudspeaker arranged near the audio collection device 211.

FIG. 3B illustrates a schematic view of another scenario consistent with the present disclosure. Based on FIG. 2, as shown in FIG. 3B, when the user is at a location B of the room 2, the audio collection device 221 may be the only audio collection device that collects the audio data from the user.

In some embodiments, analyzing the collected audio data to obtain the analysis result (102 in FIG. 1) can include performing a semantic analysis on the audio data to obtain a specific semantic meaning of the audio data. Correspondingly, performing the processing to obtain the response information for the audio data based on the analysis result can include providing a response based on the semantic information.

That is, the information that the user wants to acquire may be determined based on the semantic meaning of the audio from the user. For example, when the user generates an audio of “notebook, open the XX application,” the corresponding response may include the notebook opening the XX application.

Further, the response information may include a response result fed back to the user when the electronic apparatus obtains the response result (e.g., opens an application program like music player). The specific response information may be an audio prompt message. For example, in the aforementioned scenario, the response information may be an audio of “XX application has been opened”.

It should be understood that, the response information may be information obtained based on the response result. In some embodiments, the response information may be an audio prompt message. The specific content of the response information may be related to the response result. For example, when no response result is obtained for the audio data sent by the user, the response information may be prompted as “process failed.” Specific contents of the response information may be related to specific scenarios, and the present disclosure is not intended to be limiting.

Further, the method of obtaining the response information may be determined based on a preset relationship list between the response information and the response results. For example, a list may be configured in the electronic apparatus, and through the list, the response information needs to be outputted may be obtained based on the response results corresponding to various applications. Optionally, the corresponding relationship between the response information and the response results in the list may be updated when an application is installed in or uninstalled from the electronic apparatus.

For example, when a new application is installed in the electronic apparatus, the corresponding relationship between the response information and the response results may be updated. Further, if an application is uninstalled from the electronic apparatus, response results corresponding to the application and the response information corresponding to the response results may be deleted.

Optionally, when configuring an audio collection device, an audio output device may be configured in a corresponding location. Optionally, the audio output device may be a loudspeaker.

Further, the ratio between the audio output devices and the audio collection devices may be set to be 1:1. That is, an audio output device may be arranged close to each audio collection device. Under such situation, the physical location of an audio output device may be considered as the physical location of a corresponding audio collection device.

In some embodiments, the ratio between the audio output devices and the audio collection devices may not be 1:1. That is, the number of the audio output devices may be greater than or smaller than the number of the audio collection devices. Regardless of the ratio between the audio output devices and the audio collection devices, in one space, at least one audio output device needs to be arranged.

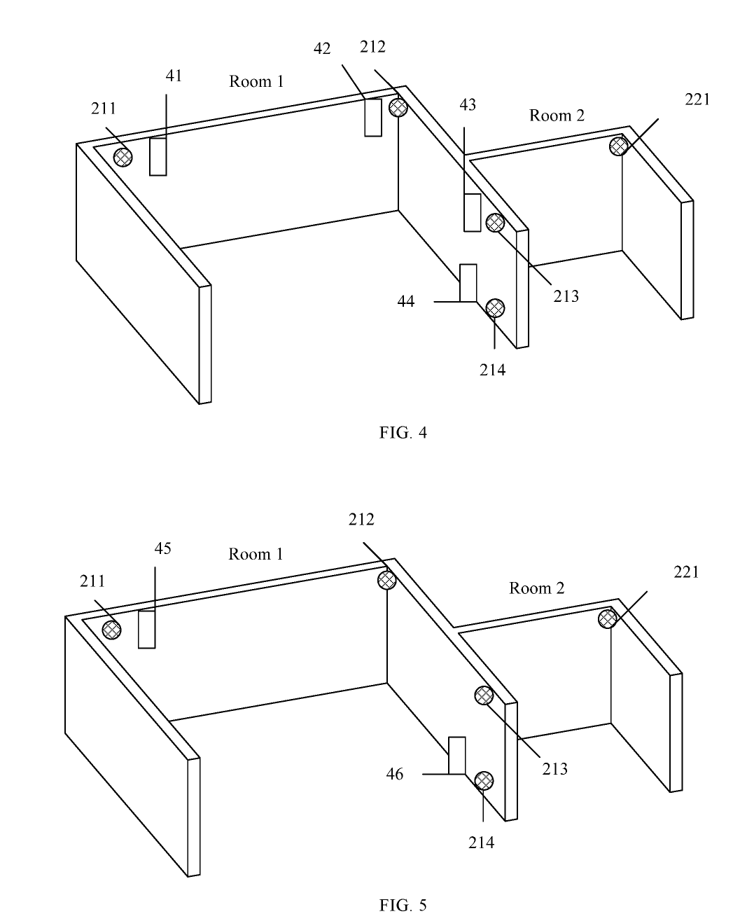

For example, based on FIG. 2, FIG. 3A, and FIG. 3B, FIG. 4 illustrates a schematic view of another scenario consistent with disclosed embodiments. As shown in FIG. 4, given the room 1 as an example, the audio collection devices 211, 212, 213, and 214 are arranged in the room 1. Further, audio output devices 41, 42, 43, and 44 are arranged close to the audio collection devices 211, 212, 213, and 214, respectively. That is, the ratio between the audio collection devices and the audio output devices is 1:1.

In another scenario, the number of the audio output devices may be smaller than the number of the audio collection devices. For example, FIG. 5 illustrates a schematic view of a scenario consistent with disclosed embodiments. As shown in FIG. 5, four audio collection devices (i.e., audio collection devices 211, 212, 213, and 214) and two audio output devices (i.e., audio output devices 45 and 46) are arranged in the room 1. In some embodiments, the audio output device 45 may be arranged close to the audio collection device 211, and the audio output device 46 may be arranged close to the audio collection device 214. The two audio output devices may be arranged approximately at two ends of the longest diagonal line of the room 1.

Further, when a plurality of audio output devices are arranged in the same space as the at least part of the audio collection devices and one or more audio collection devices are respectively arranged at approximately the same physical location as corresponding audio output devices, one target audio output device may be selected from the plurality of audio output devices corresponding to the at least part of audio collection devices that collect the audio data to output the response information.

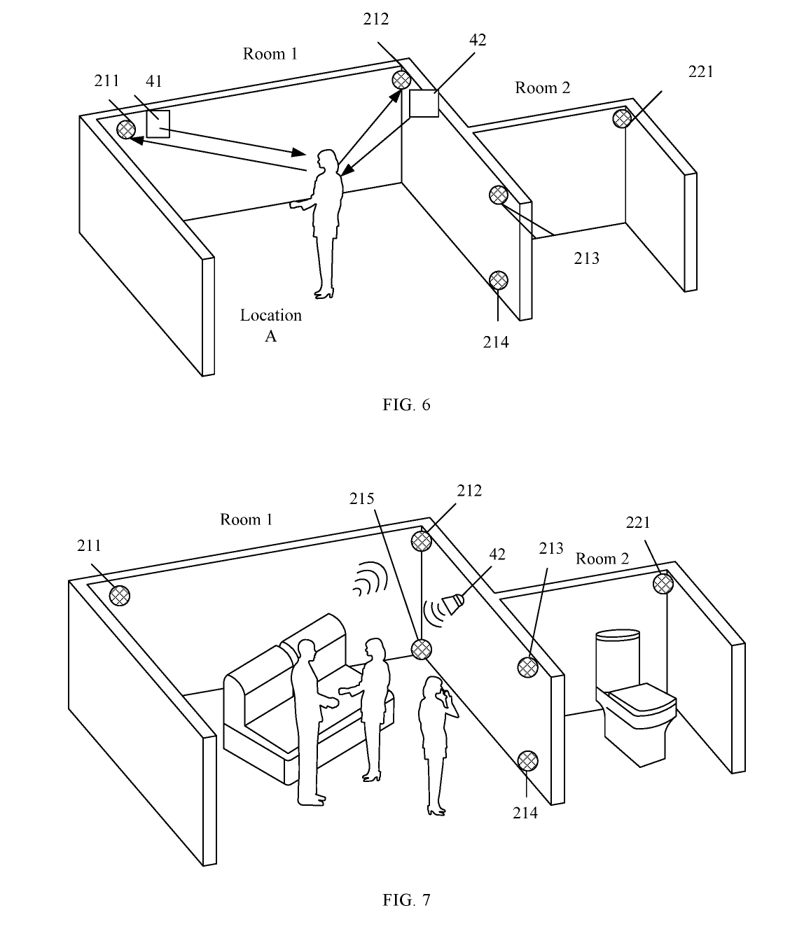

For example, based on FIG. 4, FIG. 6 illustrates a schematic view of another scenario consistent with disclosed embodiments. Different from FIG. 4, in FIG. 6, instead of four audio output devices, two audio output devices 41 and 42 are arranged in the same room (i.e., room 1) as the four audio collection devices 211, 212, 213, and 214. The user may generate audio data at the location A, and the audio collection devices 211 and 212 may be configured for collecting the audio data from the user. Further, through analysis by the electronic apparatus, the response information is obtained. The audio output devices 41 and 42 may be both configured for output of the response information. In some embodiments, one of the two audio output devices (e.g., the audio output device 41) may be selected to output the response information.

Further, a method of determining whether an audio output device is located in a same space as the at least part of the audio collection devices may include: based on the physical location of the at least part of the audio collection devices and the physical location of the at least one audio output device, selecting an audio output device with a shortest distance to the at least part of audio collection devices to output the response information.

In some embodiments, the method of determining whether an audio output device is located in a same space as the at least part of the audio collection devices may include: based on the physical locations of the at least part of audio collection devices, selecting at least one audio output device with a distance to the at least part of the audio collection devices shorter than a distance threshold to output the response information.

That is, based on the physical location of each audio collection device and the physical location of each audio output device, the response information may be outputted by one or more audio output devices corresponding to the shortest distance between each audio collection device among the at least part of the audio collection devices and the audio output devices, or the response information may be outputted by selecting one or more audio output devices showing a distance shorter than the threshold.

As such, by using the aforementioned solution, the electronic apparatus may, based on the audio data collected by at least part of the audio collection devices among a plurality of audio collection devices, obtain a corresponding analysis result. Further, based on the response result obtained corresponding to the analysis result, the response information is outputted via the audio output devices disposed in the same space as the at least part of the audio collection devices. Thus, the convenience to use the electronic apparatus by the user may be improved, such that the scenarios in which the disclosed method can be utilized may become richer and the efficiency of the user in using the disclosed electronic apparatus may be improved.

The present disclosure provides an information processing method applicable to an electronic apparatus. The electronic apparatus may be configured for establishing a communication connection with at least one audio collection device, and at least part of audio collection devices among the at least one audio collection device have physical locations different from the physical location of the electronic apparatus. The information processing method is described in detail below with reference to FIG. 1.

101: acquiring audio data collected by at least part of at least one audio collection device.

102: analyzing the collected audio data to obtain a analysis result, and based on the analysis result, performing processing to obtain response information for the audio data.

103: through an audio output device disposed in a same space as the at least part of the audio collection devices, outputting the response information.

In one example, the disclosed audio collection device may be a microphone in any form. The at least one audio collection device may form an audio collection array. Further, when the at least one audio collection device is disposed at different physical locations of a target space, sounds from different physical locations and surroundings thereof may be collected.

As described above, the audio data may be collected by at least part of the at least one audio collection device. Optionally, the number of the at least part of the audio collection device may be one or more, and through the process at 101, what is obtained is the collected audio data.

When the number of the at least part of the audio collection device is one, it may be understood that one audio collection device collects the audio data. When the number of the at least part of the audio collection devices is two or more, it may be understood that the user is in a target space where a plurality of audio collection devices are able to collect the audio data of the user, and the plurality of audio collection devices may each collect audio data.

Further, two or more sub-spaces may exist in the target space, and the two or more sub-spaces may be connected via one or more connection devices. For example, FIG. 2 illustrates a schematic view of a scenario consistent with the present disclosure.

As shown in FIG. 2, the target space may be a house including two sub-spaces, and the two sub-spaces may be two rooms denoted by room 1 and room 2. One or more audio collection devices may be respectively provided in each room. For example, as shown in FIG. 2, four audio collection devices are disposed in room 1, including audio collection device 211, audio collection device 212, audio collection device 213, and audio collection device 214. One audio collection device is disposed in room 2, i.e., audio collection device 221.

Based on FIG. 2, as shown in FIG. 3A, when a user is back home and stands at a location A of the room 1, the user may make a sound, and the audio collection devices 211, 212, 213, and 214 may all collect audio data from the user. That is, the audio collection devices 211, 212, 213, and 214 may be considered as the aforementioned at least part of the audio collection devices. Optionally, when the user is relatively close to the audio collection device 211, the audio collection device 211 may be the only audio collection device that collects the audio data from the user. Under such situation, the audio collection device 211 may be treated as the at least part of the audio collection devices.

In some embodiments, as shown in FIG. 3B, when the user is at a location B of the room 2, the audio collection device 221 may be the only audio collection device that collects the audio data from the user.

In some embodiments, analyzing the collected audio data to obtain the analysis result (102 in FIG. 1) can include: analyzing the collected audio data to obtain audio characteristic information corresponding to the audio data; based on the audio characteristic information corresponding to the audio data, detecting whether the audio data is generated by at least two users; and if the audio data is generated by at least two users, acquiring an identity (ID) characteristic of each user.

In these embodiments, the number of users that generate the audio data may be determined. For example, FIG. 7 illustrates a schematic view of another scenario consistent with the present disclosure. As shown in FIG. 7, a plurality of audio collection devices (e.g., five audio collection devices 211, 212, 213, 214, and 215) are arranged in room 1, and one or more audio collection devices (e.g., an audio collection device 221) are arranged in room 2. A plurality of users (e.g., three users) gather together in the room 1.

Further, the room 1 may be, for example, a living room with a sofa for hosting guests or an office for holding a meeting, and the room 2 may be, for example, a restroom for example. The four audio collection devices 212, 213, 214, and 215 are installed near the four corners of a side wall of the room 1 that is partially shared by the room 1 and the room 2, and an audio output device 42 is arranged near the top edge of the same side wall.

Thus, through the aforementioned approach, the audio characteristic information corresponding to at least one of the three users may be extracted from the audio data obtained in a certain period of time. For example, as illustrated in FIG. 7, for the three users standing in the room 1, three different types of audio characteristic information may be detected, such that the number of the current users in the room 1 may be determined to be three. Optionally, the certain period of time may be set based on actual situations, for example, the period of time may be 10 minutes.

It should be understood that, different users correspond to different audio characteristic information. For example, the audio characteristic information may be differentiated by the differences between the major frequency and the minor frequency. As another example, the amplitude characteristic of the voice may be applied to determine whether a plurality of users generated the audio.

Further, when the audio data is determined to be generated by at least two users, the ID characteristic of each user may be acquired based on the audio characteristic information of the users. Optionally, the ID characteristic may include adult, infant, or child. In some embodiments, the ID characteristic may include male or female.

In some embodiments, the method may further include: when at least two users are determined to have generated the audio data, determining whether a user of a target type exists. If a user of the target type exists, information may not be extracted from the audio of the user of the target type.

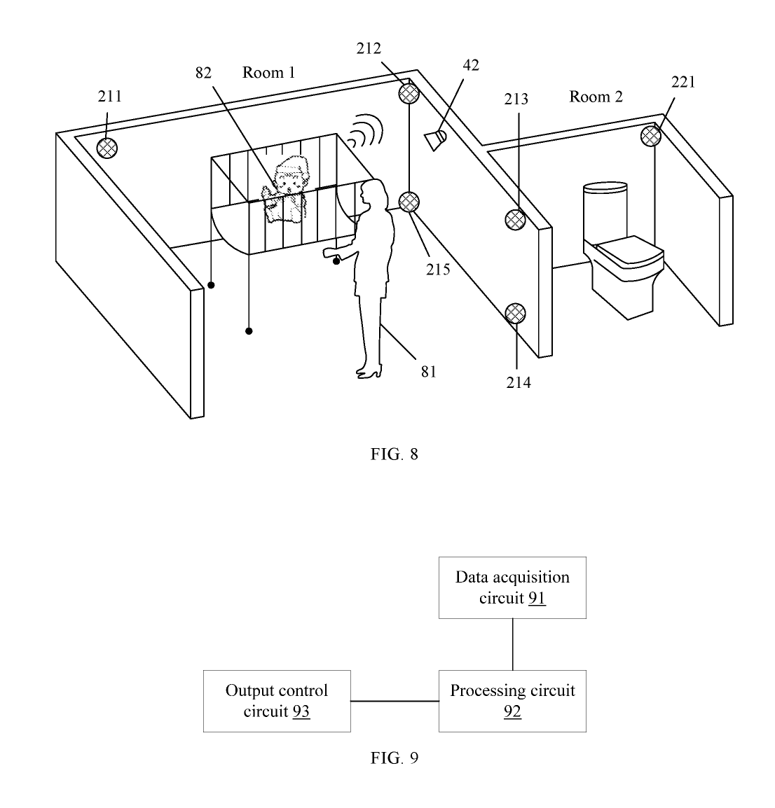

For example, FIG. 8 illustrates a schematic view of another scenario consistent with the present disclosure. Referring to FIG. 8, the configuration of a plurality of audio collection devices and an audio output device are the same as that in FIG. 7, and thus are not repeatedly described herein. The difference lies in that, in FIG. 8, the room 1 may be a bedroom and an infant 82 may sit in a crib in the room 1. Further, an adult 81 (e.g., the infant's mother) may enter the room 1 and stay with the infant 82.

When the adult 81 and the infant 82 make sounds at the same time, a plurality of audio collection devices may collect audio data from the adult 81 and the infant 82, and through analysis, the ID characteristics of the two users (i.e., the adult 81 and the infant 82) may be acquired. Further, when the ID characteristic of one of the users is determined to be an infant, no response is made to the corresponding user. In some embodiments, when the ID characteristic of one of the users is determined to be an infant, whether the audio data generated by the infant is crying is analyzed, and if the audio data generated by the infant is determined to be crying, corresponding response information may be sent to the audio output device for broadcasting.

Optionally, the response information broadcast by the audio output device may be soothing music to comfort the infant, such that the infant may not cry too much. The figure illustrating the present scenario is for illustrative purposes only, and other situations may exist. That is, the present disclosure is not limited thereto.

In some other embodiments, analyzing the collected audio data to obtain the analysis result (102 in FIG. 1) can include: analyzing the collected audio data to obtain audio characteristic information corresponding to the audio data; based on the audio characteristic information corresponding to the audio data, detecting whether the audio data is generated by at least two users; if the audio data is generated by at least two users, based on the audio characteristic information, determining whether a target user exists among the at least one user, if the target user exists among the at least one user, processing is performed based on the analysis result of the audio data from the target user to obtain response information corresponding to the audio data, and otherwise, no processing is performed on the analysis result.

Optionally, the audio characteristic information of at least one user (e.g., the target user) may be pre-stored in the electronic apparatus. For the content included in the audio characteristic information, reference can be made to aforementioned descriptions, and thus detailed description thereof is omitted.

Further, a method of determining whether the target user exists among the at least one user that generated the audio data may include: after extracting the audio characteristic information of at least one user, matching audio characteristic information of each of the at least one user with the pre-stored audio characteristic information of the target user to determine whether the target user exists.

In some embodiments, when the target user is determined to exist, the audio information generated by the target user may be analyzed. In some embodiments, the audio data of all users are analyzed, and only the analysis result of the target user is further extracted.

Further, the analysis result of the audio data may comprise information other than the audio characteristic information. For example, the analysis result may comprise the content of the information. In one embodiment, the audio data of the target user may be acquired and analyzed, and the content of the audio data may be extracted. Further, the content of the audio data may include a command sent by the target user, such as “open XX application”.

Further, performing the processing to obtain the response information for the audio data based on the analysis result can include providing a response based on the semantic information. That is, the information that the user wants to acquire may be determined based on the semantic meaning of the audio from the user. For example, when the user generates an audio of “notebook, open the XX application,” the corresponding response may include the notebook opening the XX application.

Further, the response information may include a response result fed back to the user when the electronic apparatus obtains the response result (e.g., opens an application program like music player). The specific response information may be an audio prompt message. For example, in the aforementioned scenario, the response information may be an audio of “XX application has been opened”.

It should be understood that, the response information may be information obtained based on the response result. In some embodiments, the response information may be an audio prompt message. The specific content of the response information may be related to the response result. For example, when no response result is obtained for the audio data sent by the user, the response information may be prompted as “process failed.” Specific contents of the response information may be related to specific scenarios, and the present disclosure is not intended to be limiting.

Further, the method of obtaining the response information may be determined based on a preset relationship list between the response information and the response results. For example, a list may be configured in the electronic apparatus, and through the list, the response information needs to be outputted may be obtained based on the response results corresponding to various applications. Optionally, the corresponding relationship between the response information and the response results in the list may be updated when an application is installed in or uninstalled from the electronic apparatus.

For example, when a new application is installed in the electronic apparatus, the corresponding relationship between the response information and the response results may be updated. Further, if an application is uninstalled from the electronic apparatus, response results corresponding to the application and the response information corresponding to the response results may be deleted.

Optionally, when configuring an audio collection device, an audio output device may be configured in a corresponding location. Optionally, the audio output device may be a loudspeaker.

Further, the ratio between the audio output devices and the audio collection devices may be set to be 1:1. That is, an audio output device may be arranged close to each audio collection device. Under such situation, the physical location of an audio output device may be considered as the physical location of a corresponding audio collection device.

In some embodiments, the ratio between the audio output devices and the audio collection devices may not be 1:1. That is, the number of the audio output devices may be greater than or smaller than the number of the audio collection devices. Regardless of the ratio between the audio output devices and the audio collection devices, in one space, at least one audio output device needs to be arranged.

Further, when a plurality of audio output devices are arranged in the same space as the at least part of the audio collection devices and one or more audio collection devices are respectively arranged at approximately the same physical location as corresponding audio output devices, one target audio output device may be selected from the plurality of audio output devices corresponding to the at least part of audio collection devices that collect the audio data to output the response information.

Further, a method of determining whether an audio output device is located in a same space as the at least part of the audio collection devices may include: based on the physical location of the at least part of the audio collection devices and the physical location of the at least one audio output device, selecting an audio output device with a shortest distance to the at least part of audio collection devices to output the response information.

In some embodiments, the method of determining whether an audio output device is located in a same space as the at least part of the audio collection devices may include: based on the physical locations of the at least part of audio collection devices, selecting at least one audio output device with a distance to the at least part of the audio collection devices shorter than a distance threshold to output the response information.

That is, based on the physical location of each audio collection device and the physical location of each audio output device, the response information may be outputted by one or more audio output devices corresponding to the shortest distance between each audio collection device among the at least part of the audio collection devices and the audio output devices, or the response information may be outputted by selecting one or more audio output devices showing a distance shorter than the threshold.

As such, by using the aforementioned solution, the electronic apparatus may, based on the audio data collected by at least part of the audio collection devices among a plurality of audio collection devices, obtain a corresponding analysis result. Further, based on the response result obtained corresponding to the analysis result, the response information is outputted via the audio output devices disposed in the same space as the at least part of the audio collection devices. Thus, the convenience to use the electronic apparatus by the user may be improved, such that the scenarios in which the disclosed method can be utilized may become richer and the efficiency of the user in using the disclosed electronic apparatus may be improved.

The present disclosure provides an information processing method applicable to an electronic apparatus. The electronic apparatus may be configured for establishing a communication connection with at least one audio collection device, and at least part of audio collection devices among the at least one audio collection device have physical locations different from the physical location of the electronic apparatus. The information processing method is described in detail below with reference to FIG. 1.

101: acquiring audio data collected by at least part of at least one audio collection device.

102: analyzing the collected audio data to obtain a analysis result, and based on the analysis result, performing processing to obtain response information for the audio data.

103: through an audio output device disposed in a same space as the at least part of the audio collection devices, outputting the response information.

In one example, the disclosed audio collection device may be a microphone in any form. The at least one audio collection device may form an audio collection array. Further, when the at least one audio collection device is disposed at different physical locations of a target space, sounds from different physical locations and surroundings thereof may be collected.

As described above, the audio data may be collected by at least part of the at least one audio collection device. Optionally, the number of the at least part of the audio collection device may be one or more, and through the process at 101, what is obtained is the collected audio data.

When the number of the at least part of the audio collection device is one, it may be understood that one audio collection device collects the audio data. When the number of the at least part of the audio collection devices is two or more, it may be understood that the user is in a target space where a plurality of audio collection devices are able to collect the audio data of the user, and the plurality of audio collection devices may each collect audio data.

Further, two or more sub-spaces may exist in the target space, and the two or more sub-spaces may be connected via one or more connection devices. For example, FIG. 2 illustrates a schematic view of a scenario consistent with the present disclosure.

As shown in FIG. 2, the target space may be a house including two sub-spaces, and the two sub-spaces may be two rooms denoted by room 1 and room 2. One or more audio collection devices may be respectively provided in each room. For example, as shown in FIG. 2, four audio collection devices are disposed in room 1, including audio collection device 211, audio collection device 212, audio collection device 213, and audio collection device 214. One audio collection device is disposed in room 2, i.e., audio collection device 221.

Based on FIG. 2, as shown in FIG. 3A, when a user is back home and stands at a location A of the room 1, the user may make a sound, and the audio collection devices 211, 212, 213, and 214 may all collect audio data from the user. That is, the audio collection devices 211, 212, 213, and 214 may be considered as the aforementioned at least part of the audio collection devices. Optionally, when the user is relatively close to the audio collection device 211, the audio collection device 211 may be the only audio collection device that collects the audio data from the user. Under such situation, the audio collection device 211 may be treated as the at least part of the audio collection devices.

In some embodiments, as shown in FIG. 3B, when the user is at a location B of the room 2, the audio collection device 221 may be the only audio collection device that collects the audio data from the user.

In some embodiments, the method may further include determining whether to perform analysis on the collected audio data, for example, based on the location of the user. For example, the method may further include: acquiring a target location of the audio data; and based on the target location of the audio data, determining whether to perform analysis on the audio data.

Further, acquiring the target location of the audio data may include: acquiring an audio amplitude characteristic of the audio data through at least one audio collection device; and based on the physical location corresponding to each of the at least one audio collection device and the audio amplitude characteristic of audio data acquired by each of the at least one audio collection device, determining the target location of the audio data.

In some embodiments, as shown in FIG. 2, the physical location of an audio collection device may be pre-stored in the electronic apparatus, for example, when the audio collection device is being arranged. For example, the physical location may be coordinate information, or relative coordinate information in the space. Further, the coordinate information may include longitude and latitude information, and may further include height information. The relative coordinate information may include reference coordinates based on the current space, and the location and height in the space are used as the relative coordinate information.

Further, based on the target location, determining whether analysis needs to be performed on the audio data may include: based on preset sub-space coordinates where the audio data is not processed, determining whether the audio data needs to be analyzed. In some embodiments, processing on the audio data may not be performed in certain sub-spaces, and such sub-spaces may include, for example, a living room or a restroom, etc. In some other embodiments, processing on the audio data may not be performed during certain period(s) of time, or a function of processing the audio data may be turned on or off according to the user's selection.

Further, when the audio data is collected, a plurality of audio collection devices may collect the audio data, and different audio collection devices may collect different audio amplitude characteristics. Further, different audio amplitude characteristics may be applied to describe volumes of the voices collected by different audio collection devices.

Based on the physical locations of different audio collection devices and the volume of a collected voice, the target location where the audio data is generated may be calculated. For example, a vector diagram may be established in the electronic apparatus, in which the amplitude characteristic of the voice is applied as the radius, and the locations of the audio collection devices that collect the audio data are each applied as a center for drawing circles using the aforementioned radius. Further, interacting point of the circles corresponding to the plurality of audio collection devices may be found, and such interacting point may be treated as the target location.

In some embodiments, when the target user is determined to exist, the audio information generated by the target user may be analyzed. In some embodiments, the audio data of all users are analyzed, and only the analysis result of the target user is further extracted.

Further, the analysis result of the audio data may comprise information other than the audio characteristic information. For example, the analysis result may comprise the content of the information. In one embodiment, the audio data of the target user may be acquired and analyzed, and the content of the audio data may be extracted. Further, the content of the audio data may include a command sent by the target user, such as “open XX application”.

Further, performing the processing to obtain the response information for the audio data based on the analysis result can include providing a response based on the semantic information. That is, the information that the user wants to acquire may be determined based on the semantic meaning of the audio from the user. For example, when the user generates an audio of “notebook, open the XX application,” the corresponding response may include the notebook opening the XX application.

Further, the response information may include a response result fed back to the user when the electronic apparatus obtains the response result (e.g., opens an application program like music player). The specific response information may be an audio prompt message. For example, in the aforementioned scenario, the response information may be an audio of “XX application has been opened”.

It should be understood that, the response information may be information obtained based on the response result. In some embodiments, the response information may be an audio prompt message. The specific content of the response information may be related to the response result. For example, when no response result is obtained for the audio data sent by the user, the response information may be prompted as “process failed.” Specific contents of the response information may be related to specific scenarios, and the present disclosure is not intended to be limiting.

Further, the method of obtaining the response information may be determined based on a preset relationship list between the response information and the response results. For example, a list may be configured in the electronic apparatus, and through the list, the response information needs to be outputted may be obtained based on the response results corresponding to various applications. Optionally, the corresponding relationship between the response information and the response results in the list may be updated when an application is installed in or uninstalled from the electronic apparatus.

For example, when a new application is installed in the electronic apparatus, the corresponding relationship between the response information and the response results may be updated. Further, if an application is uninstalled from the electronic apparatus, response results corresponding to the application and the response information corresponding to the response results may be deleted.

Optionally, when configuring an audio collection device, an audio output device may be configured in a corresponding location. Optionally, the audio output device may be a loudspeaker.

Further, the ratio between the audio output devices and the audio collection devices may be set to be 1:1. That is, an audio output device may be arranged close to each audio collection device. Under such situation, the physical location of an audio output device may be considered as the physical location of a corresponding audio collection device.

In some embodiments, the ratio between the audio output devices and the audio collection devices may not be 1:1. That is, the number of the audio output devices may be greater than or smaller than the number of the audio collection devices. Regardless of the ratio between the audio output devices and the audio collection devices, in one space, at least one audio output device needs to be arranged.

Further, when a plurality of audio output devices are arranged in the same space as the at least part of the audio collection devices and one or more audio collection devices are respectively arranged at approximately the same physical location as corresponding audio output devices, one target audio output device may be selected from the plurality of audio output devices corresponding to the at least part of audio collection devices that collect the audio data to output the response information.

Further, a method of determining whether an audio output device is located in a same space as the at least part of the audio collection devices may include: based on the physical location of the at least part of the audio collection devices and the physical location of the at least one audio output device, selecting an audio output device with a shortest distance to the at least part of audio collection devices to output the response information.

In some embodiments, the method of determining whether an audio output device is located in a same space as the at least part of the audio collection devices may include: based on the physical locations of the at least part of audio collection devices, selecting at least one audio output device with a distance to the at least part of the audio collection devices shorter than a distance threshold to output the response information.

That is, based on the physical location of each audio collection device and the physical location of each audio output device, the response information may be outputted by one or more audio output devices corresponding to the shortest distance between each audio collection device among the at least part of the audio collection devices and the audio output devices, or the response information may be outputted by selecting one or more audio output devices showing a distance shorter than the threshold.

As such, by using the aforementioned solution, the electronic apparatus may, based on the audio data collected by at least part of the audio collection devices among a plurality of audio collection devices, obtain a corresponding analysis result. Further, based on the response result obtained corresponding to the analysis result, the response information is outputted via the audio output devices disposed in the same space as the at least part of the audio collection devices. Thus, the convenience to use the electronic apparatus by the user may be improved, such that the scenarios in which the disclosed method can be utilized may become richer and the efficiency of the user in using the disclosed electronic apparatus may be improved.

The present disclosure provides an electronic apparatus, and the electronic apparatus may establish a communication connection with at least one audio collection device. At least part of the at least one audio collection device may have different physical locations from the electronic apparatus. FIG. 9 illustrates a schematic structural diagram showing components of an electronic apparatus consistent with the present disclosure. As shown in FIG. 9, the electronic apparatus includes a data acquisition circuit 91, a processing circuit 92, and an output control circuit 93. The processing circuit 92 may be, for example, a central processing unit (CPU).

The data acquisition circuit 91 may be configured for acquiring audio data collected by the at least part of the at least one audio collection device. The processing circuit 92 may be configured for analyzing the collected audio data to obtain a analysis result, and based on the analysis result, performing processing to obtain response information for the audio data. The output control circuit 93 may be configured for, through an audio output device in a same space as the at least part of the audio collection devices, outputting the response information.

In one example, the disclosed audio collection device may be a microphone in any form. The at least one audio collection device may form an audio collection array. Further, when the at least one audio collection device is disposed at different physical locations of a target space, sounds from different physical locations and surroundings thereof may be collected.

The data acquisition circuit 91 may be configured for acquiring the audio data collected by the at least part of the at least one audio collection devices. Optionally, the number of the at least part of the audio collection device may be one or more, and through the process at 101, what is obtained is the collected audio data.

When the number of the at least part of the audio collection device is one, it may be understood that one audio collection device collects the audio data. When the number of the at least part of the audio collection devices is two or more, it may be understood that the user is in a target space where a plurality of audio collection devices are able to collect the audio data of the user, and the plurality of audio collection devices may each collect audio data.

Further, two or more sub-spaces may exist in the target space, and the two or more sub-spaces may be connected via one or more connection devices. For example, FIG. 2 illustrates a schematic view of a scenario consistent with the present disclosure.

As shown in FIG. 2, the target space may be a house including two sub-spaces, and the two sub-spaces may be two rooms denoted by room 1 and room 2. One or more audio collection devices may be respectively provided in each room. For example, as shown in FIG. 2, four audio collection devices are disposed in room 1, including audio collection device 211, audio collection device 212, audio collection device 213, and audio collection device 214. One audio collection device is disposed in room 2, i.e., audio collection device 221.

Based on FIG. 2, as shown in FIG. 3A, when a user is back home and stands at a location A of the room 1, the user may make a sound, and the audio collection devices 211, 212, 213, and 214 may all collect audio data from the user. That is, the audio collection devices 211, 212, 213, and 214 may be considered as the aforementioned at least part of the audio collection devices. Optionally, when the user is relatively close to the audio collection device 211, the audio collection device 211 may be the only audio collection device that collects the audio data from the user. Under such situation, the audio collection device 211 may be treated as the at least part of the audio collection devices.

In some embodiments, as shown in FIG. 3B, when the user is at a location B of the room 2, the audio collection device 221 may be the only audio collection device that collects the audio data from the user.

The processing circuit 92 may be configured for analyzing the collected audio data to obtain a analysis result, and performing semantic analysis to obtain a specific semantic meaning of the audio data.

Correspondingly, performing the processing to obtain the response information for the audio data based on the analysis result can include providing a response based on the semantic information. That is, the information that the user wants to acquire may be determined based on the semantic meaning of the audio from the user. For example, when the user generates an audio of “notebook, open the XX application,” the corresponding response may include the notebook opening the XX application.

Further, the response information may include a response result fed back to the user when the electronic apparatus obtains the response result (e.g., opens an application program like music player). The specific response information may be an audio prompt message. For example, in the aforementioned scenario, the response information may be an audio of “XX application has been opened”.

It should be understood that, the response information may be information obtained based on the response result. In some embodiments, the response information may be an audio prompt message. The specific content of the response information may be related to the response result. For example, when no response result is obtained for the audio data sent by the user, the response information may be prompted as “process failed.” Specific contents of the response information may be related to specific scenarios, and the present disclosure is not intended to be limiting.

Further, the method of obtaining the response information may be determined based on a preset relationship list between the response information and the response results. For example, a list may be configured in the electronic apparatus, and through the list, the response information needs to be outputted may be obtained based on the response results corresponding to various applications. Optionally, the corresponding relationship between the response information and the response results in the list may be updated when an application is installed in or uninstalled from the electronic apparatus.

For example, when a new application is installed in the electronic apparatus, the corresponding relationship between the response information and the response results may be updated. Further, if an application is uninstalled from the electronic apparatus, response results corresponding to the application and the response information corresponding to the response results may be deleted.

When configuring the audio collection device, an audio output device may be correspondingly configured in a corresponding location. For example, the audio output device may be a loudspeaker.

Further, the ratio between the audio output devices and the audio collection devices may be set to be 1:1. That is, an audio output device may be arranged close to each audio collection device. Under such situation, the physical location of an audio output device may be considered as the physical location of a corresponding audio collection device.

In some embodiments, the ratio between the audio output devices and the audio collection devices may not be 1:1. That is, the number of the audio output devices may be greater than or smaller than the number of the audio collection devices. Regardless of the ratio between the audio output devices and the audio collection devices, in one space, at least one audio output device needs to be arranged.

For example, as shown in FIG. 4, given the room 1 as an example, the audio collection devices 211, 212, 213, and 214 are arranged in the room 1. Further, audio output devices 41, 42, 43, and 44 are arranged close to the audio collection devices 211, 212, 213, and 214, respectively. That is, the ratio between the audio collection devices and the audio output devices is 1:1.

In another scenario, the number of the audio output devices may be smaller than the number of the audio collection devices. For example, as shown in FIG. 5, four audio collection devices (i.e., audio collection devices 211, 212, 213, and 214) and two audio output devices (i.e., audio output devices 45 and 46) are arranged in the room 1. In some embodiments, the audio output device 45 may be arranged close to the audio collection device 211, and the audio output device 46 may be arranged close to the audio collection device 214. The two audio output devices may be arranged approximately at two ends of the longest diagonal line of the room 1.

Further, when a plurality of audio output devices are arranged in the same space as the at least part of the audio collection devices and one or more audio collection devices are respectively arranged at approximately the same physical location as corresponding audio output devices, one target audio output device may be selected from the plurality of audio output devices corresponding to the at least part of audio collection devices that collect the audio data to output the response information.

For example, as shown in FIG. 6, two audio output devices 41 and 42 are arranged in the same room (i.e., room 1) as the four audio collection devices 211, 212, 213, and 214. The user may generate audio data at the location A, and the audio collection devices 211 and 212 may be configured for collecting the audio data from the user. Further, through analysis by the electronic apparatus, the response information is obtained. The audio output devices 41 and 42 may be both configured for output of the response information. In some embodiments, one of the two audio output devices (e.g., the audio output device 41) may be selected to output the response information.

In some embodiments, the output control circuit 93 may be configured for, based on the physical location of the at least part of the audio collection devices and the physical location of the at least one audio output device, selecting an audio output device with a shortest distance to the at least part of audio collection devices to output the response information

In some other embodiments, the output control circuit 93 may be configured for, based on the physical locations of the at least part of audio collection devices, selecting at least one audio output device with a distance to the at least part of the audio collection devices shorter than a distance threshold to output the response information.

That is, based on the physical location of each audio collection device and the physical location of each audio output device, the response information may be outputted by one or more audio output devices corresponding to the shortest distance between each audio collection device among the at least part of the audio collection devices and the audio output devices, or the response information may be outputted by selecting one or more audio output devices showing a distance shorter than the threshold.

As such, by using the aforementioned solution, the electronic apparatus may, based on the audio data collected by at least part of the audio collection devices among a plurality of audio collection devices, obtain a corresponding analysis result. Further, based on the response result obtained corresponding to the analysis result, the response information is outputted via the audio output devices disposed in the same space as the at least part of the audio collection devices. Thus, the convenience to use the electronic apparatus by the user may be improved, such that the scenarios in which the disclosed method can be utilized may become richer and the efficiency of the user in using the disclosed electronic apparatus may be improved.

The present disclosure provides an electronic apparatus, and the electronic apparatus may establish a communication connection with at least one audio collection device. At least part of the at least one audio collection device may have different physical locations from the electronic apparatus. As shown in FIG. 9, the electronic apparatus includes the data acquisition circuit 91, the processing circuit 92, and the output control circuit 93.

The data acquisition circuit 91 may be configured for acquiring audio data collected by the at least part of the at least one audio collection device. The processing circuit 92 may be configured for analyzing the collected audio data to obtain a analysis result, and based on the analysis result, performing processing to obtain response information for the audio data. The output control circuit 93 may be configured for, through an audio output device in a same space as the at least part of the audio collection devices, outputting the response information.

In one example, the disclosed audio collection device may be a microphone in any form. The at least one audio collection device may form an audio collection array. Further, when the at least one audio collection device is disposed at different physical locations of a target space, sounds from different physical locations and surroundings thereof may be collected.

The data acquisition circuit 91 may be configured for acquiring the audio data collected by the at least part of the at least one audio collection devices. Optionally, the number of the at least part of the audio collection device may be one or more, and what is obtained by one or more audio collection device is the collected audio data.

When the number of the at least part of the audio collection device is one, it may be understood that one audio collection device collects the audio data. When the number of the at least part of the audio collection devices is two or more, it may be understood that the user is in a target space where a plurality of audio collection devices are able to collect the audio data of the user, and the plurality of audio collection devices may each collect audio data.

Further, two or more sub-spaces may exist in the target space, and the two or more sub-spaces may be connected via one or more connection devices. For example, FIG. 2 illustrates a schematic view of a scenario consistent with the present disclosure.

As shown in FIG. 2, the target space may be a house including two sub-spaces, and the two sub-spaces may be two rooms denoted by room 1 and room 2. One or more audio collection devices may be respectively provided in each room. For example, as shown in FIG. 2, four audio collection devices are disposed in room 1, including audio collection device 211, audio collection device 212, audio collection device 213, and audio collection device 214. One audio collection device is disposed in room 2, i.e., audio collection device 221.

Based on FIG. 2, as shown in FIG. 3A, when a user is back home and stands at a location A of the room 1, the user may make a sound, and the audio collection devices 211, 212, 213, and 214 may all collect audio data from the user. That is, the audio collection devices 211, 212, 213, and 214 may be considered as the aforementioned at least part of the audio collection devices. Optionally, when the user is relatively close to the audio collection device 211, the audio collection device 211 may be the only audio collection device that collects the audio data from the user. Under such situation, the audio collection device 211 may be treated as the at least part of the audio collection devices.

In some embodiments, as shown in FIG. 3B, when the user is at a location B of the room 2, the audio collection device 221 may be the only audio collection device that collects the audio data from the user.

In some embodiments, the processing circuit 91 may be configured for: analyzing the collected audio data to obtain audio characteristic information corresponding to the audio data; based on the audio characteristic information corresponding to the audio data, detecting whether the audio data is generated by at least two users; and if the audio data is generated by at least two users, acquiring an identity (ID) characteristic of each user.

In these embodiments, the number of users that generate the audio data may be determined. For example, FIG. 7 illustrates a scenario with a plurality of users. Thus, through the aforementioned approach, the audio characteristic information corresponding to at least one of the plurality of users may be extracted from the audio data obtained in a certain period of time.

It should be understood that, different users correspond to different audio characteristic information. For example, the audio characteristic information may be differentiated by the differences between the major frequency and the minor frequency. As another example, the amplitude characteristic of the voice may be applied to determine whether a plurality of users generated the audio.

Further, when the audio data is determined to be generated by at least two users, the ID characteristic of each user may be acquired based on the audio characteristic information of the users. Optionally, the ID characteristic may include adult, infant, or child. In some embodiments, the ID characteristic may include male or female.

In some embodiments, when at least two users are determined to have generated the audio data, whether a user of a target type exists can be determined. If a user of the target type exists, information may not be extracted from the audio of the user of the target type.

For example, as shown in FIG. 8, the adult 81 and the infant 82 are both in the room. When the adult 81 and the infant 82 make sounds at the same time, a plurality of audio collection devices may collect audio data from the adult 81 and the infant 82, and through analysis, the ID characteristics of the two users (i.e., the adult 81 and the infant 82) may be acquired. Further, when the ID characteristic of one of the users is determined to be an infant, no response is made to the corresponding user. In some embodiments, when the ID characteristic of one of the users is determined to be an infant, whether the audio data generated by the infant is crying is analyzed, and if the audio data generated by the infant is determined to be crying, corresponding response information may be sent to the audio output device for broadcasting.

Optionally, the response information broadcast by the audio output device may be soothing music to comfort the infant, such that the infant may not cry too much. The figure illustrating the present scenario is for illustrative purposes only, and other situations may exist. That is, the present disclosure is not limited thereto.

In some other embodiments, the processing circuit 91 may be configured for: analyzing the collected audio data to obtain audio characteristic information corresponding to the audio data; based on the audio characteristic information corresponding to the audio data, detecting whether the audio data is generated by at least two users; if the audio data is generated by at least two users, based on the audio characteristic information, determining whether a target user exists among the at least one user, if the target user exists among the at least one user, processing is performed based on the analysis result of the audio data from the target user to obtain response information corresponding to the audio data, and otherwise, no processing is performed on the analysis result.

Optionally, the audio characteristic information of at least one user (e.g., the target user) may be pre-stored in the electronic apparatus. For the content included in the audio characteristic information, reference can be made to aforementioned descriptions, and thus detailed description thereof is omitted.

Further, a method of determining whether the target user exists among the at least one user that generated the audio data may include: after extracting the audio characteristic information of at least one user, matching audio characteristic information of each of the at least one user with the pre-stored audio characteristic information of the target user to determine whether the target user exists.

In some embodiments, when the target user is determined to exist, the audio information generated by the target user may be analyzed. In some embodiments, the audio data of all users are analyzed, and only the analysis result of the target user is further extracted.

Further, the analysis result of the audio data may comprise information other than the audio characteristic information. For example, the analysis result may comprise the content of the information. In one embodiment, the audio data of the target user may be acquired and analyzed, and the content of the audio data may be extracted. Further, the content of the audio data may include a command sent by the target user, such as “open XX application”.

Further, performing the processing to obtain the response information for the audio data based on the analysis result can include providing a response based on the semantic information. That is, the information that the user wants to acquire may be determined based on the semantic meaning of the audio from the user. For example, when the user generates an audio of “notebook, open the XX application,” the corresponding response may include the notebook opening the XX application.

Further, the response information may include a response result fed back to the user when the electronic apparatus obtains the response result (e.g., opens an application program like music player). The specific response information may be an audio prompt message. For example, in the aforementioned scenario, the response information may be an audio of “XX application has been opened”.

It should be understood that, the response information may be information obtained based on the response result. In some embodiments, the response information may be an audio prompt message. The specific content of the response information may be related to the response result. For example, when no response result is obtained for the audio data sent by the user, the response information may be prompted as “process failed.” Specific contents of the response information may be related to specific scenarios, and the present disclosure is not intended to be limiting.

Further, the method of obtaining the response information may be determined based on a preset relationship list between the response information and the response results. For example, a list may be configured in the electronic apparatus, and through the list, the response information needs to be outputted may be obtained based on the response results corresponding to various applications. Optionally, the corresponding relationship between the response information and the response results in the list may be updated when an application is installed in or uninstalled from the electronic apparatus.

For example, when a new application is installed in the electronic apparatus, the corresponding relationship between the response information and the response results may be updated. Further, if an application is uninstalled from the electronic apparatus, response results corresponding to the application and the response information corresponding to the response results may be deleted.

As such, by using the aforementioned solution, the electronic apparatus may, based on the audio data collected by at least part of the audio collection devices among a plurality of audio collection devices, obtain a corresponding analysis result. Further, based on the response result obtained corresponding to the analysis result, the response information is outputted via the audio output devices disposed in the same space as the at least part of the audio collection devices. Thus, the convenience to use the electronic apparatus by the user may be improved, such that the scenarios in which the disclosed method can be utilized may become richer and the efficiency of the user in using the disclosed electronic apparatus may be improved.

The present disclosure provides an electronic apparatus, and the electronic apparatus may establish a communication connection with at least one audio collection device. At least part of the at least one audio collection device may have different physical locations from the electronic apparatus. As shown in FIG. 9, the electronic apparatus includes the data acquisition circuit 91, the processing circuit 92, and the output control circuit 93.

The data acquisition circuit 91 may be configured for acquiring audio data collected by the at least part of the at least one audio collection device. The processing circuit 92 may be configured for analyzing the collected audio data to obtain a analysis result, and based on the analysis result, performing processing to obtain response information for the audio data. The output control circuit 93 may be configured for, through an audio output device in a same space as the at least part of the audio collection devices, outputting the response information.

In one example, the disclosed audio collection device may be a microphone in any form. The at least one audio collection device may form an audio collection array. Further, when the at least one audio collection device is disposed at different physical locations of a target space, sounds from different physical locations and surroundings thereof may be collected.

Optionally, the number of the at least part of the audio collection device may be one or more, and what is obtained by one or more audio collection device is the collected audio data.

When the number of the at least part of the audio collection device is one, it may be understood that one audio collection device collects the audio data. When the number of the at least part of the audio collection devices is two or more, it may be understood that the user is in a target space where a plurality of audio collection devices are able to collect the audio data of the user, and the plurality of audio collection devices may each collect audio data.

Further, two or more sub-spaces may exist in the target space, and the two or more sub-spaces may be connected via one or more connection devices. For example, as shown in FIG. 2, the target space may be a house including two sub-spaces, and the two sub-spaces may be two rooms denoted by room 1 and room 2. One or more audio collection devices may be respectively provided in each room. For example, as shown in FIG. 2, four audio collection devices are disposed in room 1, including audio collection device 211, audio collection device 212, audio collection device 213, and audio collection device 214. One audio collection device is disposed in room 2, i.e., audio collection device 221.

Based on FIG. 2, as shown in FIG. 3A, when a user is back home and stands at a location A of the room 1, the user may make a sound, and the audio collection devices 211, 212, 213, and 214 may all collect audio data from the user. That is, the audio collection devices 211, 212, 213, and 214 may be considered as the aforementioned at least part of the audio collection devices. Optionally, when the user is relatively close to the audio collection device 211, the audio collection device 211 may be the only audio collection device that collects the audio data from the user. Under such situation, the audio collection device 211 may be treated as the at least part of the audio collection devices.

In some embodiments, as shown in FIG. 3B, when the user is at a location B of the room 2, the audio collection device 221 may be the only audio collection device that collects the audio data from the user.

In some embodiments, whether to perform analysis on the collected audio data can be determined, for example, further based on the location of the user. For example, the processing circuit 92 may be further configured for: acquiring a target location of the audio data; and based on the target location of the audio data, determining whether to perform analysis on the audio data.

Further, acquiring the target location of the audio data may include: acquiring an audio amplitude characteristic of the audio data through at least one audio collection device; and based on the physical location corresponding to each of the at least one audio collection device and the audio amplitude characteristic of audio data acquired by each of the at least one audio collection device, determining the target location of the audio data.

In some embodiments, as shown in FIG. 2, the physical location of an audio collection device may be pre-stored in the electronic apparatus, for example, when the audio collection device is being arranged. For example, the physical location may be coordinate information, or relative coordinate information in the space. Further, the coordinate information may include longitude and latitude information, and may further include height information. The relative coordinate information may include reference coordinates based on the current space, and the location and height in the space are used as the relative coordinate information.

Further, based on the target location, determining whether analysis needs to be performed on the audio data may include: based on preset sub-space coordinates where the audio data is not processed, determining whether the audio data needs to be analyzed. In some embodiments, processing on the audio data may not be performed in certain sub-spaces, and such sub-spaces may include, for example, a living room or a restroom, etc. In some other embodiments, processing on the audio data may not be performed during certain period(s) of time, or a function of processing the audio data may be turned on or off according to the user's selection.

Further, when the audio data is collected, a plurality of audio collection devices may collect the audio data, and different audio collection devices may collect different audio amplitude characteristics. Further, different audio amplitude characteristics may be applied to describe volumes of the voices collected by different audio collection devices.

Based on the physical locations of different audio collection devices and the volume of a collected voice, the target location where the audio data is generated may be calculated. For example, a vector diagram may be established in the electronic apparatus, in which the amplitude characteristic of the voice is applied as the radius, and the locations of the audio collection devices that collect the audio data are each applied as a center for drawing circles using the aforementioned radius. Further, interacting point of the circles corresponding to the plurality of audio collection devices may be found, and such interacting point may be treated as the target location.

In some embodiments, when the target user is determined to exist, the audio information generated by the target user may be analyzed. In some embodiments, the audio data of all users are analyzed, and only the analysis result of the target user is further extracted.

Further, the analysis result of the audio data may comprise information other than the audio characteristic information. For example, the analysis result may comprise the content of the information. In one embodiment, the audio data of the target user may be acquired and analyzed, and the content of the audio data may be extracted. Further, the content of the audio data may include a command sent by the target user, such as “open XX application”.

Further, performing the processing to obtain the response information for the audio data based on the analysis result can include providing a response based on the semantic information. That is, the information that the user wants to acquire may be determined based on the semantic meaning of the audio from the user. For example, when the user generates an audio of “notebook, open the XX application,” the corresponding response may include the notebook opening the XX application.

Further, the response information may include a response result fed back to the user when the electronic apparatus obtains the response result (e.g., opens an application program like music player). The specific response information may be an audio prompt message. For example, in the aforementioned scenario, the response information may be an audio of “XX application has been opened”.

It should be understood that, the response information may be information obtained based on the response result. In some embodiments, the response information may be an audio prompt message. The specific content of the response information may be related to the response result. For example, when no response result is obtained for the audio data sent by the user, the response information may be prompted as “process failed.” Specific contents of the response information may be related to specific scenarios, and the present disclosure is not intended to be limiting.

Further, the method of obtaining the response information may be determined based on a preset relationship list between the response information and the response results. For example, a list may be configured in the electronic apparatus, and through the list, the response information needs to be outputted may be obtained based on the response results corresponding to various applications. Optionally, the corresponding relationship between the response information and the response results in the list may be updated when an application is installed in or uninstalled from the electronic apparatus.

For example, when a new application is installed in the electronic apparatus, the corresponding relationship between the response information and the response results may be updated. Further, if an application is uninstalled from the electronic apparatus, response results corresponding to the application and the response information corresponding to the response results may be deleted.

Optionally, when configuring an audio collection device, an audio output device may be configured in a corresponding location. Optionally, the audio output device may be a loudspeaker.

Further, the ratio between the audio output devices and the audio collection devices may be set to be 1:1. That is, an audio output device may be arranged close to each audio collection device. Under such situation, the physical location of an audio output device may be considered as the physical location of a corresponding audio collection device.

In some embodiments, the ratio between the audio output devices and the audio collection devices may not be 1:1. That is, the number of the audio output devices may be greater than or smaller than the number of the audio collection devices. Regardless of the ratio between the audio output devices and the audio collection devices, in one space, at least one audio output device needs to be arranged.

Further, when a plurality of audio output devices are arranged in the same space as the at least part of the audio collection devices and one or more audio collection devices are respectively arranged at approximately the same physical location as corresponding audio output devices, one target audio output device may be selected from the plurality of audio output devices corresponding to the at least part of audio collection devices that collect the audio data to output the response information.

Further, a method of determining whether an audio output device is located in a same space as the at least part of the audio collection devices may include: based on the physical location of the at least part of the audio collection devices and the physical location of the at least one audio output device, selecting an audio output device with a shortest distance to the at least part of audio collection devices to output the response information.

In some embodiments, the method of determining whether an audio output device is located in a same space as the at least part of the audio collection devices may include: based on the physical locations of the at least part of audio collection devices, selecting at least one audio output device with a distance to the at least part of the audio collection devices shorter than a distance threshold to output the response information.

That is, based on the physical location of each audio collection device and the physical location of each audio output device, the response information may be outputted by one or more audio output devices corresponding to the shortest distance between each audio collection device among the at least part of the audio collection devices and the audio output devices, or the response information may be outputted by selecting one or more audio output devices showing a distance shorter than the threshold.

As such, by using the aforementioned solution, the electronic apparatus may, based on the audio data collected by at least part of the audio collection devices among a plurality of audio collection devices, obtain a corresponding analysis result. Further, based on the response result obtained corresponding to the analysis result, the response information is outputted via the audio output devices disposed in the same space as the at least part of the audio collection devices. Thus, the convenience to use the electronic apparatus by the user may be improved, such that the scenarios in which the disclosed method can be utilized may become richer and the efficiency of the user in using the disclosed electronic apparatus may be improved.

It should be noted that, terms “comprising” and “including” or any other variations thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

The sequence numbers of the embodiments of the present disclosure are merely for ease of description, and do not imply the preference throughout the embodiments.

Through the foregoing description of the implementation manners, it is clear to those skilled in the relevant art that the present disclosure may be implemented by software plus a universal hardware platform, and may also be implemented by hardware. An electronic apparatus consistent with the disclosure can include a storage medium (for example, a ROM/RAM, a magnetic disk, or an optical disc) storing instructions, and a processor executing the instructions to perform a method consistent with the disclosure, such as one of the above-described methods. The instructions can also instruct a terminal device (which may be a mobile phone, a computer, a server, or a network device) to perform the method according to the embodiments of the present disclosure.

The above descriptions are merely example embodiments of the present disclosure, and are not intended to limit the scope of the present disclosure. Any equivalent modification made to the structure or processes based on content of this specification and the accompanying drawings for direct or indirect use in other related technical fields shall all fall within the scope of the present disclosure.

What is claimed is:

1. An information processing method comprising:
acquiring audio data collected by at least one remotely-arranged audio collection device;
analyzing the audio data to obtain a analysis result;
performing processing based on the analysis result to obtain response information corresponding to the audio data; and
transmitting the response information to an audio output device in a same space as the at least one audio collection device for broadcasting.

2. The method according to claim 1, further comprising:
acquiring a target location of the audio data; and
determining whether to analyze the audio data based on the target location of the audio data.

3. The method according to claim 2, wherein acquiring the target location of the audio data includes:
acquiring an audio amplitude characteristic of the audio data; and
determining the target location of the audio data based on a physical location of the at least one audio collection device and the audio amplitude characteristic of the audio data.

4. The method according to claim 3, wherein determining whether to analyze the audio data includes:
determining whether the audio data needs to be analyzed based on preset sub-space coordinates where the audio data is not processed.

5. The method according to claim 1, wherein performing processing to obtain the response information includes:
searching in a preset relationship list between analysis results and response information to obtain the response information corresponding to the audio data.

6. The method according to claim 5, further comprising:
updating the preset relationship list in response to an application being installed or uninstalled.

7. The method according to claim 1, wherein analyzing the audio data to obtain the analysis result includes:
analyzing the audio data to obtain audio characteristic information corresponding to the audio data;
detecting whether the audio data is generated by at least two audio sources based on the audio characteristic information; and
in response to the audio data being generated by the at least two audio sources, acquiring an identity characteristic of at least one of the at least two audio sources.

8. The method according to claim 1, wherein:
analyzing the audio data to obtain the analysis result includes:
extracting audio characteristic information corresponding to the audio data, and
performing the processing includes:
detecting whether the audio data is generated by at least one audio source based on the audio characteristic information;
in response to the audio data being generated by the at least one audio source, determining whether the at least one audio source includes a target audio source based on the audio characteristic information; and
in response to the at least one audio source including the target audio source, performing the processing based on the analysis result of the audio data from the target audio source to obtain the response information corresponding to the audio data.

9. The method according to claim 1, wherein transmitting the response information to an audio output device in a same space as the at least one audio collection device includes:
transmitting the response information to one of at least one audio output device that is closest to the at least one audio collection device among the at least one audio output device.

10. The method according to claim 1, wherein transmitting the response information to an audio output device in a same space as the at least one audio collection device includes:
transmitting the response information to one of at least one audio output device that has a distance to the at least one audio collection device shorter than a distance threshold.

11. An electronic apparatus comprising:
a data acquisition circuit, wherein the data acquisition circuit acquires remotely-generated audio data collected by at least one audio collection device;
a processing circuit coupled to the data acquisition circuit, wherein the processing circuit:
analyzes the audio data to obtain a analysis result, and
performs processing based on the analysis result to obtain response information corresponding to the audio data; and
an output control circuit coupled to the processing circuit, wherein the output control circuit transmits the response information to an audio output device in a same space as the at least one audio collection device for broadcasting.

12. The apparatus according to claim 11, wherein the processing circuit further:
acquires a target location of the audio data; and
determines whether to analyze the audio data based on the target location of the audio data.

13. The apparatus according to claim 12, wherein the processing circuit further:
acquires an audio amplitude characteristic of the audio data; and
determines the target location of the audio data based on a physical location of the at least one audio collection device and the audio amplitude characteristic of the audio data.

14. The apparatus according to claim 13, wherein the processing circuit further:
determines whether the audio data needs to be analyzed based on preset sub-space coordinates where the audio data is not processed.

15. The apparatus according to claim 11, wherein the processing circuit further:
searches in a preset relationship list between analysis results and response information to obtain the response information corresponding to the audio data.

16. The apparatus according to claim 15, the processing circuit further:
updates the preset relationship list in response to an application being installed or uninstalled.

17. The apparatus according to claim 11, wherein the processing circuit further s:
analyzes the audio data to obtain audio characteristic information corresponding to the audio data;
detects whether the audio data is generated by at least two audio sources based on the audio characteristic information; and
in response to the audio data being generated by the at least two audio sources, acquires an identity characteristic of at least one of the at least two audio sources.

18. The apparatus according to claim 11, wherein the processing circuit further:
extracts audio characteristic information corresponding to the audio data, and
detects whether the audio data is generated by at least one audio source based on the audio characteristic information;
in response to the audio data being generated by the at least one audio source, determines whether the at least one audio source includes a target audio source based on the audio characteristic information; and
in response to the at least one audio source including the target audio source, performs the processing based on the analysis result of the audio data from the target audio source to obtain the response information corresponding to the audio data.

19. The apparatus according to claim 11, wherein the processing circuit further:
transmits the response information to one of at least one audio output device that is closest to the at least one audio collection device among the at least one audio output device.

20. The apparatus according to claim 11, wherein the processing circuit further:
transmits the response information to one of at least one audio output device that has a distance to the at least one audio collection device shorter than a distance threshold.
